(19) United States
(12) Patent Application Publication
(10) Pub. No.: US 2018/0074833 A1
(43) Pub. Date: Mar. 15, 2018

(54) CONFIGURING MOBILE DEVICES WITH CONNECTED ACCESSORIES FOR INCOMING COMMUNICATIONS

(71) Applicant: MOTOROLA MOBILITY LLC, Chicago, IL (US)

(72) Inventor: SNEHITHA SINGARAJU, Naperville, IL (US)

(21) Appl. No.: 15/264,927

(22) Filed: Sep. 14, 2016

(51) Int. Cl. G06F 9/445; G06F 13/10

(52) U.S. Cl. CPC G06F 9/44505; G06F 13/102

(57) ABSTRACT

A method, system, and computer program product for configuring a portable device and/or accessories connected to the portable device in response to detecting a communication. In response to detecting the communication, the portable device determines whether at least one accessory is coupled to the portable device. In response to determining at least one accessory is coupled to the portable device, at least one operating parameter associated with an operation of the at least one accessory is identified. The method further includes determining, based on the at least one identified operating parameter, at least one modification to be applied to the portable device and/or to the at least one accessory to restrict (or limit) an operation of the at least one accessory for the duration of the communication. The method further includes applying the at least one modification to the portable device and/or to the at least one accessory.

### BACKGROUND

### 1. Technical Field

The present disclosure generally relates to portable devices and in particular to an improved method for presenting communications on a portable device.

### 2. Description of the Related Art

Modern portable communication devices, such as cellular phones, may attach to external accessories. Many of these accessories may include output devices, such as an external speaker or a projector, that modify the output capabilities of the portable device. However, when these accessories are coupled to the portable communication device, they may also negatively impact the normal operation of the portable device during communications (e.g., a phone call) between the portable device and another device. For example, an external accessory that includes a digital image projector may generate additional noise via an active cooling system that may make it difficult to hear from a speaker of the portable device. In another example, an external accessory coupled to a portable device may generate additional heat that makes holding the portable device uncomfortable and/or unsafe during a phone call.

### BRIEF DESCRIPTION OF THE DRAWINGS

The description of the illustrative embodiments is to be read in conjunction with the accompanying drawings, wherein:

FIG. 1 illustrates a portable device within which certain aspects of the disclosure can be practiced, in accordance with one or more embodiments;

FIG. 2 illustrates an example portable device configured to apply at least one modification to the portable device and/or to at least one accessory connected to the portable device in response to detecting a communication, in accordance with one or more embodiments;

FIG. 3A is an illustration depicting a front view of a portable device and an accessory that is physically attachable to the portable device, in accordance with one or more embodiments;

FIG. 3B is an illustration depicting a rear view of a portable device and an accessory that is physically attachable to the portable device, in accordance with one or more embodiments;

FIG. 3C is an illustration depicting a front view of a portable device which is attached to an accessory, in accordance with one or more embodiments;

FIG. 4 is a flow chart illustrating a method for applying a modification to a portable device and/or to an accessory connected to the portable device, in accordance with one or more embodiments; and

FIG. 5 is a flow chart illustrating a method for determining a modification to apply to a portable device and/or to accessory connected to the portable device based on a present temperature of the accessory, in accordance with one or more embodiments.

### DETAILED DESCRIPTION

The illustrative embodiments provide a method, system, and computer program product for configuring a portable device and/or accessories connected to the portable device in response to detecting a communication. The method includes monitoring a portable device for a communication. In response to detecting the communication, the portable device determines whether at least one accessory is coupled to the portable device. In response to determining that at least one accessory is coupled to the portable device, the method further includes identifying at least one operating parameter associated with an operation of the at least one accessory. The method further includes determining, based on the at least one identified operating parameter, at least one modification to be applied to the portable device and/or to the at least one accessory to restrict (or limit) an operation of the at least one accessory for a duration of the communication. The method further includes applying the at least one modification to the portable device and/or to the at least one accessory.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the following figures and the remaining detailed written description. The above as well as additional objectives, features, and advantages of the present disclosure will become apparent in the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

As utilized herein, a communication refers to any exchange of audio content and/or data, including, but not limited to text, images, and/or video, between a portable communication device and at least one other electronic device. A communication may include an incoming communication and/or an outgoing communication, such as, but not limited to, a phone call, phone conference, video call (including voice over internet protocol (VOIP) transmissions), video conference, multimedia messaging service (MMS) message, and/or push-to-talk (PTT) transmission.

Those of ordinary skill in the art will appreciate that the hardware components and basic configuration depicted in the following figures may vary. For example, the illustrative components within portable communication device 100 are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

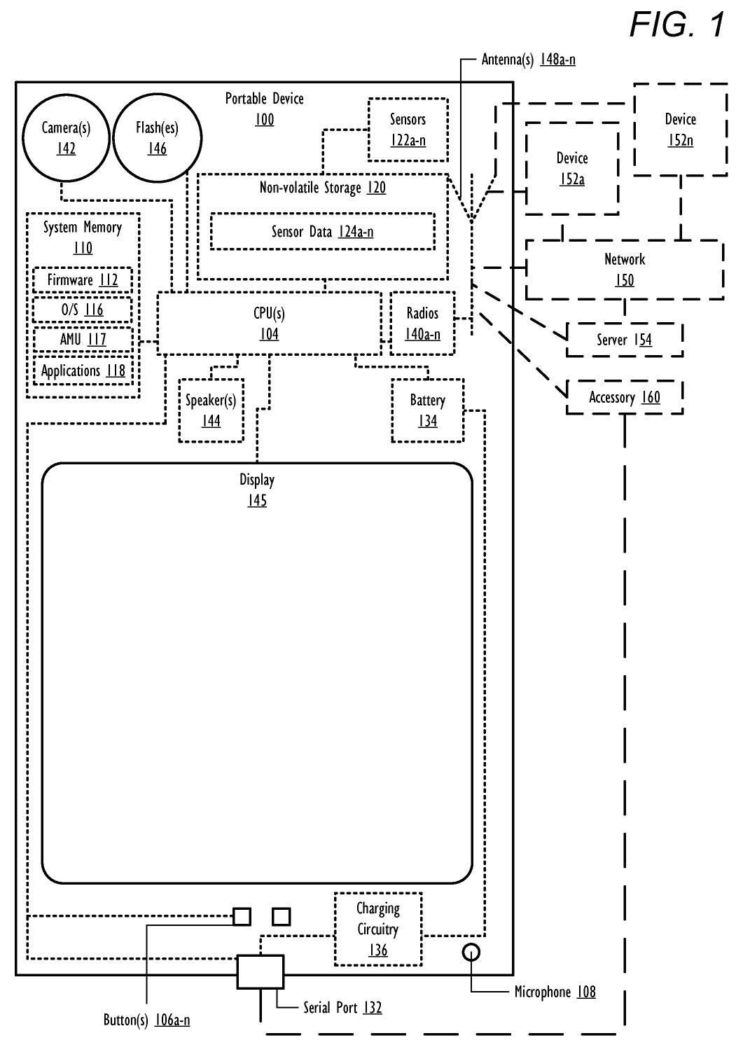

Now turning to FIG. 1, there is illustrated an example portable device 100 within which one or more of the described features of the various embodiments of the disclosure can be implemented. In one embodiment, portable device 100 can be any portable device, such as, but not limited to, a notebook computer, mobile phone, portable battery pack, smart watch, digital camera, video recorder, or tablet computer. Portable device 100 includes at least one processor or central processing unit (CPU) 104. CPU 104 is coupled to non-volatile storage 120 and system memory 110, within which firmware 112, operating system (OS) 116, accessory management utility (AMU) 117, and applications 118 can be stored for execution on CPU 104. According to one aspect, AMU 117 executes within portable device 100 to perform the various methods and functions described herein. In one or more embodiments, AMU 117 determines at least one modification to apply to portable device 100 and/or to accessory 160 in response to detecting a communication. In one embodiment, AMU 117 may exchange communications/notifications with at least one accessory 160, serial port 132 and/or another input/output (I/O) bus (not pictured) that interconnects accessory 160 with portable device 100. In one embodiment, AMU 117 may wirelessly exchange communications/notifications with at least one accessory 160 via one or more radios 140a-n. For simplicity, AMU 117 is illustrated and described as a stand-alone or separate software/firmware/logic component, which provides the specific functions and methods described below. However, in at least one embodiment, AMU 117 may be a component of, may be combined with, or may be incorporated within firmware 112, or OS 116, and/or within one or more of applications 118.

As shown, portable device 100 may include input devices and output devices that enable a user to interface with portable device 100. In the illustrated embodiment, portable device 100 includes camera(s) 142, camera flash(es) 146, display 145, hardware buttons 106a-n, microphone 108, and speaker(s) 144. Hardware buttons 106a-n are selectable buttons which are used to receive manual/tactile input from a user to control specific operations of portable device 100 and/or of applications executing thereon. In one embodiment, hardware buttons 106a-n may also include or may be connected to one or more sensors (e.g. a fingerprint scanner) and/or may be pressure sensitive. Hardware buttons 106a-n may also be directly associated with one or more functions of a graphical user interface (not pictured) and/or functions of an OS, application, or hardware of portable device 100. In one embodiment, hardware buttons 106a-n may include a keyboard. Microphone 108 may be used to receive spoken input/commands from a user. Speaker(s) 144 is used to output audio.

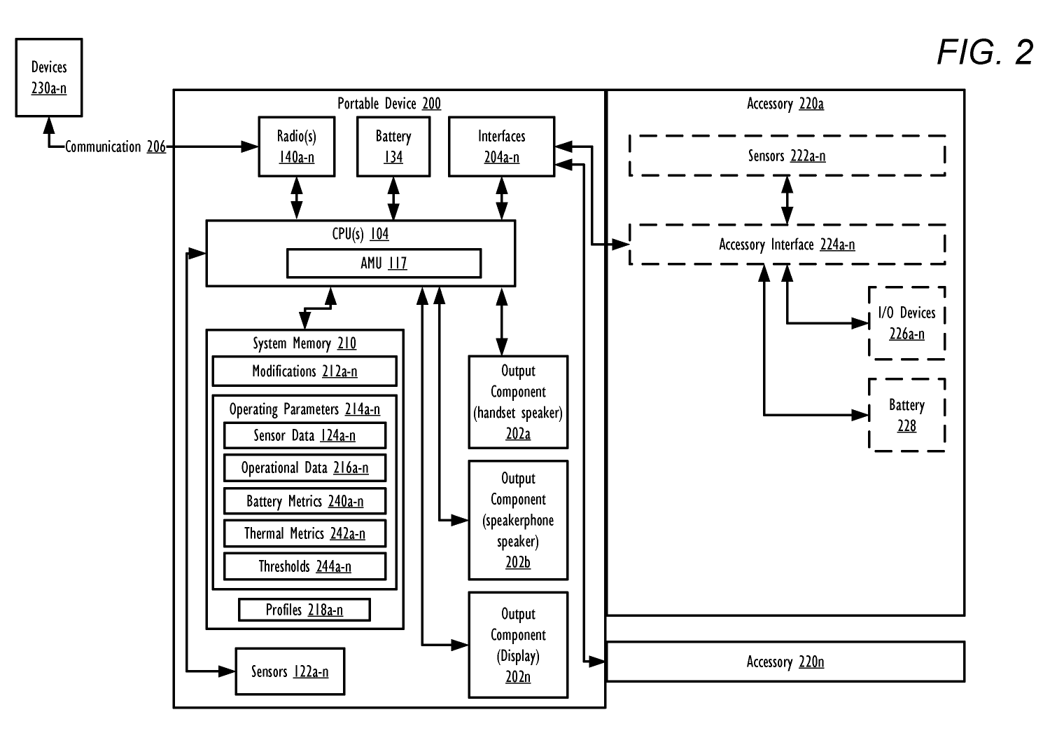

CPU(s) 104 is also coupled to sensors 122a-n. Sensors 122a-n can include, but are not limited to, at least one of: infrared (IR) sensors, thermal sensors, light sensors, proximity sensors, camera/image sensors, accelerometers, gyroscopes, magnetometers, microphones, barometers, air humidity sensors, pedometers, heart rate monitors, fingerprint sensors, radiation sensors, and iris scanners. In one or more embodiments, sensors 122a-n may record, to system memory 110 and/or non-volatile storage 120, sensor data 124a-n that may be used by AMU 117 to calculate at least one modification (e.g. modifications 212a-n, FIG. 2) to be applied to at least one of portable device 200 and the at least one accessory 160 in order to restrict an operation of the at least one accessory 160 for the duration of a communication.

Portable device 100 also includes display 145, which is capable of displaying text, media content, and/or a graphical user interface (GUI) of firmware and/or one or more applications executing on portable device 100. The GUI can be rendered by CPU 104 for viewing on display 145 or be rendered by a graphics processing unit (GPU), in one embodiment. In one embodiment, display 145 is a touch screen that is also capable of receiving touch input from a user of portable device 100, when the user is interfacing with a displayed GUI. In at least one embodiment, portable device 100 can include a plurality of virtual buttons or affordances that operate in addition to, or in lieu of, hardware buttons 106a-n. For example, portable device 100 can be equipped with a touch screen interface and provide, via a GUI, a virtual keyboard or other virtual icons for user interfacing therewith. In at least one embodiment, portable device 100 can include a plurality of virtual buttons or affordances that operate in addition to or in lieu of hardware buttons 106a-n.

Portable device 100 also includes battery 134, charging circuitry 136, and serial port 132 (e.g., a USB (universal serial bus) port) which can operate as a charging port that receives power via an external charging device (not pictured) for charging battery 134. Serial port 132 may also function as one of an input port, an output port, and a combination input/output port. In one application, serial port 132 allows a direct physical connection to and communication of data with a second device (e.g., accessory 160). Serial port 132 also provides a physical interface between charging circuitry 136 and an external charging device (not pictured) for charging battery 134. Battery 134 may include a single battery or multiple batteries for providing power to components of portable device 100. In one embodiment, battery 134 may include at least one battery that is removable and/or replaceable by an end user. In another embodiment, battery 134 may include at least one battery that is permanently secured to portable device 100.

Portable device 100 also includes one or more wireless radios 140a-n and can include one or more antenna(s) 148a-n that enable portable device 100 to wirelessly connect to, and transmit and receive voice and/or data communication to/from one or more other devices, such as devices 152a-n and server 154. As a wireless device, portable device 100 can transmit data over a wireless network 150 (e.g., a Wi-Fi network, cellular network, Bluetooth® network (including Bluetooth® low energy (BLE) networks), a wireless ad hoc network (WANET), or personal area network (PAN)). In one embodiment, portable device 100 may be further equipped with an infrared (IR) device (not pictured) for communicating with other devices using an IR connection. In another embodiment, wireless radios 140a-n may include a short-range wireless device, including, but not limited to, a near field communication (NFC) device. In still another embodiment, portable device 100 may communicate with one or more other device(s) using a wired or wireless USB connection. In one or more embodiments, devices 152a-n may include one or more accessories (e.g., accessory 160).

FIG. 2 is a block diagram illustrating an example portable device configured to apply at least one modification to the portable device and/or to at least one accessory connected to the portable device in response to detecting a communication, in accordance with one or more embodiments of the present disclosure. For consistency in the description thereof, portable device 200 is assumed to be similar to portable device 100 and include similar components. Portable device 200 includes CPU(s) 104, which executes AMU 117, memory 210, sensors 122a-n, output components 202a-n, radios 140a-n, and interfaces 204a-n. Radios 140a-n are used to facilitate communication (e.g., a phone call) with device 230a-n. Output components 202a-n include any output devices for presenting images, text, video, and/or audio. In the illustrated embodiment shown, output devices 202a-n include a first speaker (handset speaker 202a), a second speaker (speakerphone speaker 202b), and a display (display 202n). Interfaces 204a-n include one or more I/O devices that may be used to communicate with accessories 220a-n. In one embodiment, interfaces 204a-n include at least one wireless radio (e.g., radios 140a-n) and/or data port (e.g., serial port 132 of FIG. 1) for exchanging data with accessories 220a-n. In another embodiment, while directly connected to accessory interfaces 224a-n of accessories 220a-n, interfaces 204a-n may be used to provide power to, and/or receive power from, accessories 220a-n. In another embodiment, interfaces 204a-n may also be used to transmit and/or receive data and/or audio associated with communication 206 with devices 230a-n.

Each of accessories 220a-n include an accessory interface 224a-n which is coupled to I/O devices 226a-n. I/O devices 226a-n include input devices and/or output devices that enable a user to interact with accessories 220a-n such as: a projector (which may include a short-throw projector), speaker(s), camera, camera flash, display, hardware button(s), and/or microphone(s). Accessory interfaces 224a-n may optionally be connected to sensors 222a-n. Sensors 222a-n may include, but are not limited to, at least one of: infrared (IR) sensors, thermal sensors, light sensors, proximity sensors, camera/image sensors, accelerometers, gyroscopes, magnetometers, microphones, barometers, air humidity sensors, pedometers, heart rate monitors, fingerprint sensors, radiation sensors, and iris scanners. Data collected by sensors 222a-n may be stored on a memory (not pictured) of a corresponding accessory 220a-n which may be accessed by portable device 200. In another embodiment, AMU 117 may directly access and collect data from sensors 222 a-n while portable device 200 and accessories 220a-n are interconnected via interfaces 204a-n and accessory interfaces 224a-n.

Accessories 220a-n may optionally include battery 228 and/or charging circuitry (not pictured). Battery 228 may include a single battery or multiple batteries for providing power to components of accessories 220a-n. In one embodiment, accessory interfaces 224a-n may provide a connection to interfaces 204a-n of portable device 200 that enables battery 228 to provide power to portable device 100 for charging battery 134 (FIG. 1) and/or for powering components of portable device 200. In one embodiment, battery 228 may include at least one battery that is removable and/or replaceable by an end user. In another embodiment, battery 228 may include at least one battery that is permanently secured to accessory 220a-n. In another embodiment, accessories 220a-n may include a processing device (not pictured) such as a microprocessor or microcontroller that is coupled to accessory interface 224a-n, sensors 222a-n, I/O devices 226a-n, and battery 228.

AMU 117 monitors radios 140a-n and/or interfaces 204a-n for initiation of communication 206 (e.g., a phone call or video call). Communication 206 may be incoming or outgoing. In response to detecting communication 206, AMU 117 determines whether at least one of accessories 220a-n is connected to portable device 200. According to one embodiment, AMU 117 triggers the device to activate scanning for the presence of accessories 220a-n via interfaces 204a-n and/or radios 140a-n. In response to the scan identifying that none of accessories 220a-n are connected to portable device 200, AMU 117 presents communication 206 on the corresponding output component (e.g., output component (handset speaker) 202a-n) identified in a current configuration of portable device 200.

In response to determining at least one accessory 220a-n is connected to portable device 200, AMU 117 identifies operating parameters 214a-n associated with the at least one connected accessory 220a-n. In one embodiment, operating parameters 214a-n categorize and/or characterize an operation of a corresponding accessory 220a-n and/or I/O device(s) 226a-n within the corresponding accessory 220a-n. For example, operating parameters 214a-n identify a current fan speed and/or fan voltage supplied to an active cooling system of accessory 220a. In another example, operating parameters 214a-n identify a brightness of a projector light source of accessory 220a. In still another example, operating parameters 214a-n identify how long a particular accessory 220a-n has been connected to portable device 200. Operating parameters 214a-n may also include battery metrics and/or thermal metrics that are associated with portable device 200 for a usage of accessories 220a-n. In another embodiment, AMU 117 monitors sensors 122a-n and/or sensors 222a-n and stores sensor data 124a-n associated with sensors 122a-n and/or sensors 222a-n within operating parameters 214a-n. Sensor data 124a-n may include data associated with any components within portable device 200 and/or accessories 220a-n. In one embodiment, sensor data 124a-n may include at least one thermal metric that identifies a current temperature of portable device 200 and/or accessories 220a-n, and/or any components therein. In another embodiment, sensors 122a-n and/or sensors 222a-n may include one or more microphones that are used to estimate noise levels associated with accessories 220a-n.

While the illustrated embodiment shows operating parameters 214a-n are shown as being stored within memory 210, in another embodiment, portable device 200 automatically retrieves or receives operating parameters 214a-n from accessories 220a-n in response to a connection being established between portable device 200 and accessories 220a-n. In another embodiment, portable device 200 automatically retrieves operating parameters 214a-n from another device (e.g., a server or devices 230a-n) in response to a connection being established between portable device 200 and accessories 220a-n.

In response to identifying operating parameters 214a-n, AMU 117 determines at least one modification 212a-n to apply to portable device 200 and/or accessories 220a-n. In one embodiment, each of modifications 212a-n alter or restrict an operation of the at least one of accessories 220a-n (and/or I/O devices 226a-n therein) and/or to improve the quality of communication 206 for a user of portable device 200 for the duration of communication 206. In one embodiment, modifications 212a-n provide at least one instruction targeting functions/operations of a single component. In another embodiment, modifications 212a-n provide at least one instruction targeting functions/operations of several components. For example, modification 212a may disable a light source and/or reduce a fan speed of an active cooling system of a projector accessory (accessory 220a). In another example, modification 212b may disable accessory 220b entirely. In another embodiment, modifications 212a-n restrict an operation of portable device 200. For example, modification 212n disables interface 204n which provides power and/or data to a connected accessory 220n. By disabling interface 204n, AMU 117 removes power provided to accessory 220n, thus indirectly disabling accessory 220n entirely.

In another embodiment, modifications 212a-n include issuing a notification to at least one output component 202a-n of portable device 200 and/or an output component (e.g. I/O devices 226a-n) of accessories 220a-n. In one embodiment, the notification indicates, to a user of portable device 200 and/or accessories 220a-n, that a particular accessory 220a-n may be disabled or disconnected from portable device 200. In another embodiment, the notification may include an explanation, based on operating parameters 214a-n, that identifies why a particular accessory 220a-n which is currently enabled and/or physically attached to portable device 200 may not be disabled and/or detached from portable device 200. For example, the notification may contain a message that identifies accessory 220a as currently being too hot to be disconnected from portable device 200. In another example, the notification may indicate that a power currently being provided to accessory 220a will be maintained in order to reduce the current temperature of accessory 220a from an elevated temperature to a temperature where accessory 220a may be safely connected. In one embodiment, the notification may identify a current temperature of the particular accessory 220a-n and/or an estimated time when a particular accessory 220 may be disconnected.

In one embodiment, AMU 117 may evaluate thermal metrics 240a-n and/or battery metrics 242a-n within operating parameters 214a-n to categorize a particular usage and/or operation of portable device 200 and/or accessories 220a-n. In one embodiment, thermal metrics 240a-n may include, but are not limited to: historical temperature data, current temperature data, and current and/or historical heat output (e.g., radiant heat) data. It should be noted that thermal metrics 240a-n may include thermal data associated with portable device 200 and/or accessories 220a-n. In one embodiment, battery metrics 242a-n may include, but are not limited to: battery type data, battery chemistry data, battery drain rate data, and current charge (state of charge) level. It should also be noted that battery metrics 242a-n may include battery data associated with batteries of portable device 200 and/or accessories 220a-n. While thermal metrics 240a-n and/or battery metrics 242a-n are provided within operating parameters 214a-n in the illustrated embodiment, in one or more embodiments, thermal metrics 240a-n, battery metrics 242a-n, and/or evaluations of thermal metrics 240a-n and/or battery metrics 242a-n, may be stored within profiles 218a-n.

AMU 117 may evaluate thermal metrics 240a-n and/or battery metrics 242a-n to determine, for example, whether usage of a particular accessory 220a-n is contributing to a heating of portable device 200 and/or draining of battery 134. AMU 117 may apply modifications 212a-n to portable device 200 and/or accessories 220a-n based on the evaluation of thermal metrics 240a-n and/or battery metrics 242a-n. For example, AMU 117 may evaluate thermal metrics 240a-n associated with accessory 220a that are collected over a period of time to determine a heating rate at which accessory 220a heats portable device 200. AMU 117 may then apply a modification (e.g., modification 212a) to accessory 220a that establishes an operating mode of an active cooling system of accessory 220a to a particular level which counteracts the heating rate.

In one or more embodiments, operating parameters 214a-n include thresholds 244a-n which identify a particular level where modifications 212a-n are to be applied, based on collected sensor data 124a-n, thermal metrics 240a-n, and/or battery metrics 242a-n. For example, AMU 117 identifies, from battery metrics 242a-n associated with accessory 220a, a rate in which accessory 220b draws power from battery 134. In response to determining the rate of battery drain is above a first threshold (e.g., threshold 244a), AMU 117 may then apply a first modification (e.g., modification 212b) that disables accessory 220b entirely. Alternatively, in response to determining the rate of battery drain is below a second threshold (threshold 244b), AMU 117 may apply a second modification (e.g., modification 212c) that disables only a particular portion of accessory 220b (e.g., a lamp on a projector) and allows the remaining portion to continue to draw power from portable device 200. In another example, modification 212b may only be applied if a current temperature of accessory 220b is also below a safe temperature threshold (e.g., threshold 244c). In still another example, modification 212d is applied to accessory 220b in response to AMU 117 determining, based on sensor data 124a-n collected by at least one microphone (e.g., microphone 108), that a level of noise being generated by accessory 220b is above a noise threshold (e.g., threshold 244d).

In one embodiment, AMU 117 identifies a current output mode that portable device 200 is configured to utilize when presenting communication 206. For example, in a standard output mode, portable device 200 may be configured to deliver audio communication to a handset speaker (output component 202a). Based on the at least one accessory 220a-n that is connected to portable device 200 and the current output mode, AMU 117 applies at least one modification 212a-n that selects/enables an alternate output mode for presenting the audio communication at portable device 200. In another embodiment, the alternate output mode established by modifications 212a-n routes communication 206 to another location (e.g., wired headphones, devices 230a-n, and/or accessories 220b-n). For example, in response to receiving an incoming phone call, AMU 117 applies modification 212b, which routes audio associated with the incoming phone call to a Bluetooth speaker (e.g., device 230a) that is separate from portable device 200 and accessory 220a (which is currently connected to portable device 200). In another embodiment, an available speakerphone speaker is capable of providing a higher maximum volume than the handset speaker, and the alternate output mode may include modifications 212a-n which route the incoming phone call to a speakerphone speaker (output component 202b) of portable device 200, in lieu of outputting the sound associated with the phone call through the usual handset speaker (output component 202a). Thus, a user of portable device 200 and/or output component 202b may hear the incoming phone call over an increased noise generated by output component 202b (e.g., noise generated by an active cooling system) operating in the alternate output mode. In another embodiment, an alternate output mode may apply modifications 212a-n that increase a gain of at least one microphone of portable device and/or disable/enable other microphones of portable device to maximize a volume and/or clarity of a voice input for the user for communication 206.

In another embodiment, AMU 117 may determine which of a plurality of modifications 212a-n is safe to apply to accessories 220a-n based on operating parameters 214a-n. For example, AMU 117 may determine, based on operating parameters 214a-n, that accessory 220a (a projector accessory) is too hot to disconnect from portable device 200. AMU 117 may then apply, to accessory 220a, modification 212a which disables a light source of the projector, increases a fan speed of an active cooling system of accessory 220a (in order to quickly cool accessory 220a), and routes audio associated with communication 206 to a speakerphone speaker (output component 202b) that is capable of outputting audio at a volume level that is greater than an increased level of noise generated by fans of the active cooling system. Additionally, AMU 117 may also issue a notification on a display (e.g., display 202n) of portable device 200 that indicates accessory 220a as being too hot to disconnect and which provides an explanation of the modifications (modification 212a) applied to portable device 200 and accessory 220a.

In another embodiment, AMU 117 monitors operating parameters 214a-n and/or sensor data 124a-n in real time and dynamically applies modifications 212a-n in response to detecting at least one change in operating parameters 214a-n and/or sensor data 124a-n. For example, detecting communication 206 (an incoming phone call), AMU 117 determines, from sensor data 124a-n within operating parameters 214a-n, a current temperature of an attached projector accessory (accessory 220a) to be 100° F. and an amount of noise emitted by accessory 220a to be 50 decibels. AMU 117 applies, to accessory 220a, modification 212a which disables a projector light emitter (I/O device 226a) of accessory 220a and decreases a fan speed of an active cooling system (I/O device 226b) of accessory 220a (e.g., from 75% to 50%). In response determining the current temperature of accessory 220a has reached a safe temperature for disconnection (e.g., 70° F.), AMU 117 applies modification 212b, which issues a notification to at least one output component of portable device 200 and/or accessory 220a that indicates to a user that accessory 220a may be disconnected from portable device 200.

In another embodiment, AMU 117 determines at least one identifier(s) (e.g., a serial number, model number, manufacturer, or product family) that is associated with the at least one connected accessory 220a-n. In this embodiment, AMU 117 determines at least one of modification 212a-n based on the determined identifier(s). In one embodiment, at least one of modifications 212a-n is associated with a particular identifier. For example, AMU 117 may determine, based on an identifier of a particular accessory 220n, whether accessory 220n is associated with a first party (a same manufacturer of portable device 200) or third party accessory (a different manufacturer from the manufacturer of portable device 200. In response to determining accessory 220n is associated with the first party, AMU 117 retrieves at least one modification (e.g., modification 212n) which is specifically associated with the identifier. AMU 117 may then apply a first modification (e.g., modification 212a) if accessory 220n is a first party accessory or a second modification (e.g., modification 212b) if accessory 220n is a third party accessory. In one or more embodiments, AMU 117 may retrieve modifications 212a-n from a server and/or remote storage database. It should also be noted that, in embodiments where multiple accessories 220a-n are connected to portable device 200, AMU 117 may determine different modifications 212a-n to apply to each connected accessory 220a-n.

In one or more embodiments, in response to detecting an initial coupling of at least one accessory (e.g., accessory 220a) and portable device 200, AMU 117 collects, via at least one sensor (e.g., sensors 122a-n and/or sensors 222a-n), operational data 216a-n which is associated with the coupled accessory (accessory 220a). Operational data 216a-n categorizes the operation of accessory 220a over a period of time in which accessory 220a is connected to portable device 200. In one embodiment, operational data 216a-n includes an identification of an amount of data sent and/or received, temperature data, battery consumption data, and utilization data (e.g., the amount of time and/or means in which accessory 220a was being utilized by a user). Based on operational data 216a-n, AMU 117 generates profile 218a-n for each accessory 220a-n. In one embodiment, each of profiles 218a-n may identify, for a corresponding accessory 220, at least one of: a tracked usage time, an amount of heat output, a power drawn from the portable device, a current charge level (state of charge) of at least one battery, and a level of noise emitted. AMU 117 may further determine the at least one modification 212a-n to apply to a particular accessory (e.g., accessory 220a) based on a corresponding profile (e.g., profile 218a). In another embodiment, one or more profiles 218a-n may be associated with a particular identifier.

In response to applying modification 212a-n to accessories 220a-n, AMU 117 presents communication 206 on at least one output component (e.g., output components 202a-n) of portable device 200 and/or accessories 220a-n based on the applied modification 212a-n. In one or more embodiments, AMU 117 monitors radios 140a-n and interfaces 204a-n to determine whether communication 206 has been terminated. In response to detecting the termination/changing of communication 206, AMU 117 optionally reverts any changes applied to portable device 200 and/or accessory 220a based on the previously applied at least one modification 212a-n. In another embodiment, AMU 117 monitors radios 140a-n and interfaces 204a-n to determine whether communication 206 has changed to a different type of communication (e.g., a phone call being changed to a video call). In response to detecting the changing of communication 206 to a different type, AMU 117 optionally reverts any changes applied to portable device 200 and/or accessory 220a based on the previously applied modification(s) 212a-n and/or applies a different at least one alternate modification based on the new communication type. During communication 206, AMU 117 may also continually update operating parameters 214a-n, sensor data 124a-n, operational data 216a-n, and/or profile 218a-n while modifications 212a-n are applied to portable device 200 and/or accessories 220a-n.

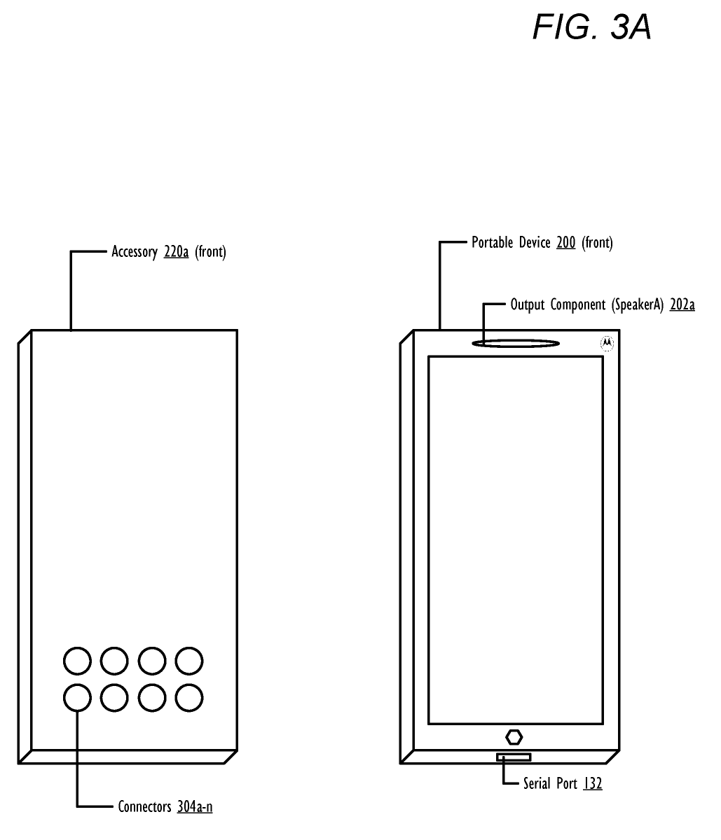

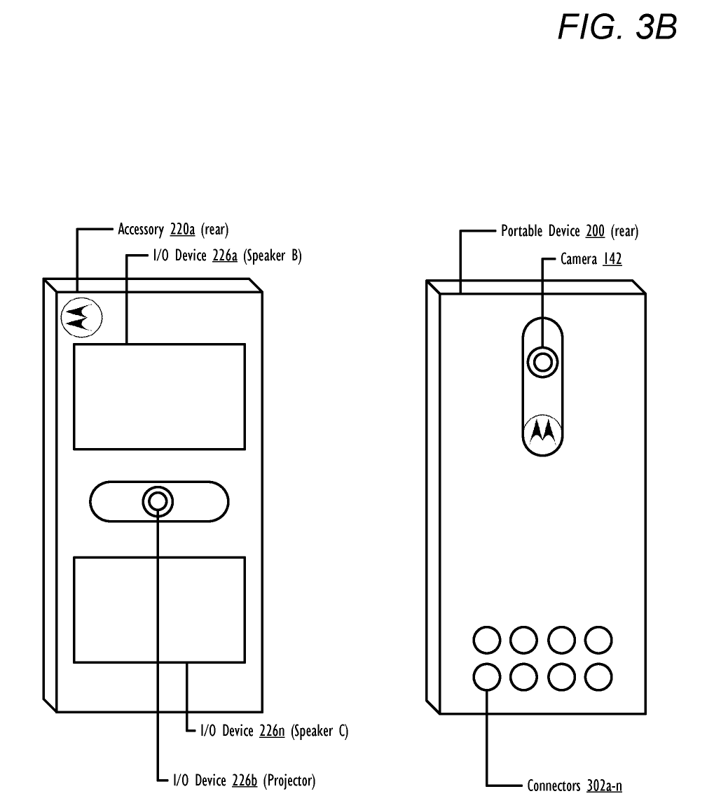

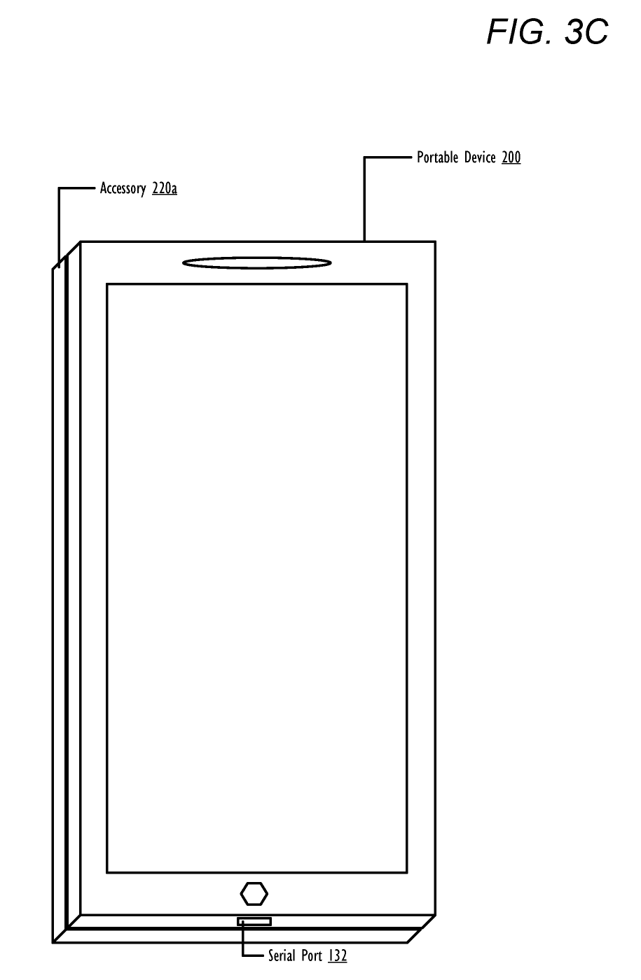

FIG. 3A is an illustration that depicts a front view of portable device 200 and an accessory that is physically attachable to portable device 200, in accordance with one or more embodiments of the present disclosure. In the example illustrated in FIG. 3a, accessory 220a includes connectors 304a-n. In one embodiment, connectors 304a-n may be connected to at least one accessory interface 224a-n of accessory 220a. The front face of accessory 220a may be physically attached to the rear side of portable device 200. When accessory 220a and portable device 200 are properly connected, connectors 304a-n are aligned with connectors 302a-n of portable device 200 (as illustrated in FIG. 3B). When a connection between connectors 304a-n and connectors 302a-n has been established, portable device 200 may transmit and/or receive data with portable device 200 via the interconnection between connectors 304a-n and connectors 302a-n. This data may include, but is not limited to, audio, video, and/or still images and/or text. In another embodiment, connectors 304a-n may be used to provide power to and/or receive power from portable device 200. In another embodiment, accessory 220a may have a dedicated connector (not pictured) for attaching to serial port 132 or another input port (not pictured) of portable device in lieu of connectors 304a-n. In still another embodiment, portable device 200 may exchange data with accessory 220a via a wireless connection (e.g., a Bluetooth connection). In one embodiment, portable device 200 and/or accessory 220a may include a physical interlocking contrivance, such as magnets or a lock mechanism, for maintaining a physical connection between portable device 200 and accessory 220a while attached.

FIG. 3B is an illustration that depicts a rear view of a portable device and an accessory that is physically attachable to the portable device, in accordance with one or more embodiments of the present disclosure. As illustrated, accessory 220a includes speaker B (I/O device 226a), a projector (I/O device 226b), and speaker C (I/O device 226n). In one embodiment, accessory 220a may receive an output from portable device 200 which includes (e.g., as audio and video). The received output may then be presented on I/O devices 226a-n.

FIG. 3C is an illustration that depicts a portable device and an accessory that is physically attached to the portable device, in accordance with one or more embodiments of the present disclosure. It should be noted that while the example embodiment depicted in FIGS. 2-3C illustrates portable device 200 and accessories 220a as being physically connected/attached, in another embodiment they may be wirelessly connected and physically separate.

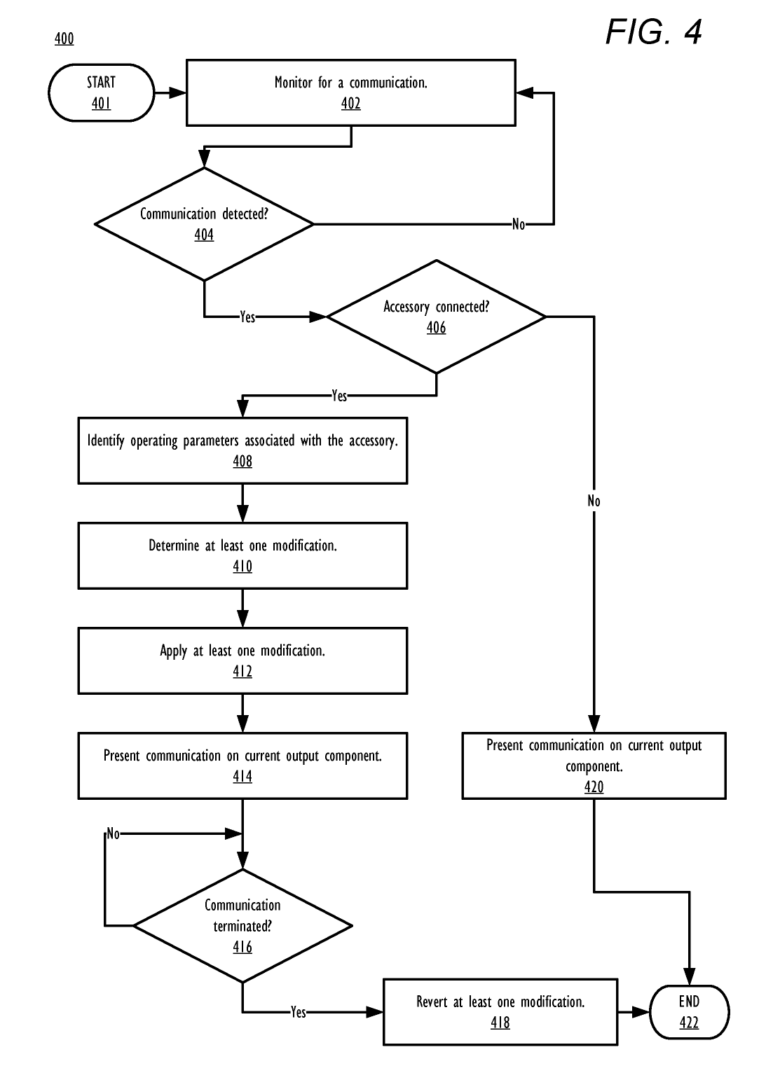

Referring now to FIG. 4, there is depicted a high-level flow-chart illustrating a method for applying at least one modification to a portable device and/or to at least one accessory connected to the portable device in response to detecting a communication, in accordance with one or more embodiments of the present disclosure. Aspects of the method are described with reference to the components of FIGS. 1-3C. Several of the processes of the method provided in FIG. 4 can be implemented by a processor (e.g., CPU 104) executing software code of respective AMU 117 within a portable device (e.g., FIG. 1 or FIG. 2). The method processes described in FIG. 4 are generally described as being performed by portable device 200.

Method 400 commences at initiator block 401 then proceeds to block 402. At block 402, processor 104 monitors portable device 200 for an incoming or outgoing communication. At block 404, the processor determines whether communication 206 has been detected. In response to determining that communication 206 has been detected, method 400 proceeds to decision block 406 and processor 104 determines whether an accessory (e.g., accessory 220a) is connected to portable device 200. In response to determining that accessory 220a is connected to portable device 200, processor 104 identifies operating parameters 214a-n associated with accessory 220a (block 408). In response to identifying operating parameters 214a-n, processor 104 determines, based on operating parameters 214a-n, at least one modification 212a-n to be applied to at least one of portable device 200 and/or accessory 220a for the duration of the communication 206 (block 410). In response to determining at least one modification 212a-n, processor 104 identifies the device associated with each of the at least one modification and applies each of the at least one modification 212a-n to the corresponding one or more of portable device 200 and accessory 220a (block 412). At block 414, processor 104 presents communication 206 on a current output component (e.g., speakerphone speaker 202b) identified in a current configuration of portable device 200 and/or accessory 220a (block 414). At decision block 416, it is determined whether communication 206 has been terminated. In response to determining communication 206 has been terminated, processor 104 reverts any changes applied to portable device 200 and/or accessory 220a based on the previously applied at least one modification 212a-n (block 418). Method 400 then terminates at block 422.

In response to determining, at decision block 406, that an accessory (e.g., accessory 220a) is not connected to portable device 200, method 400 proceeds to block 420 and communication 206 is presented on a current output component based on a current configuration of portable device 200 and/or accessory 220a. Method 400 then terminates at block 422.

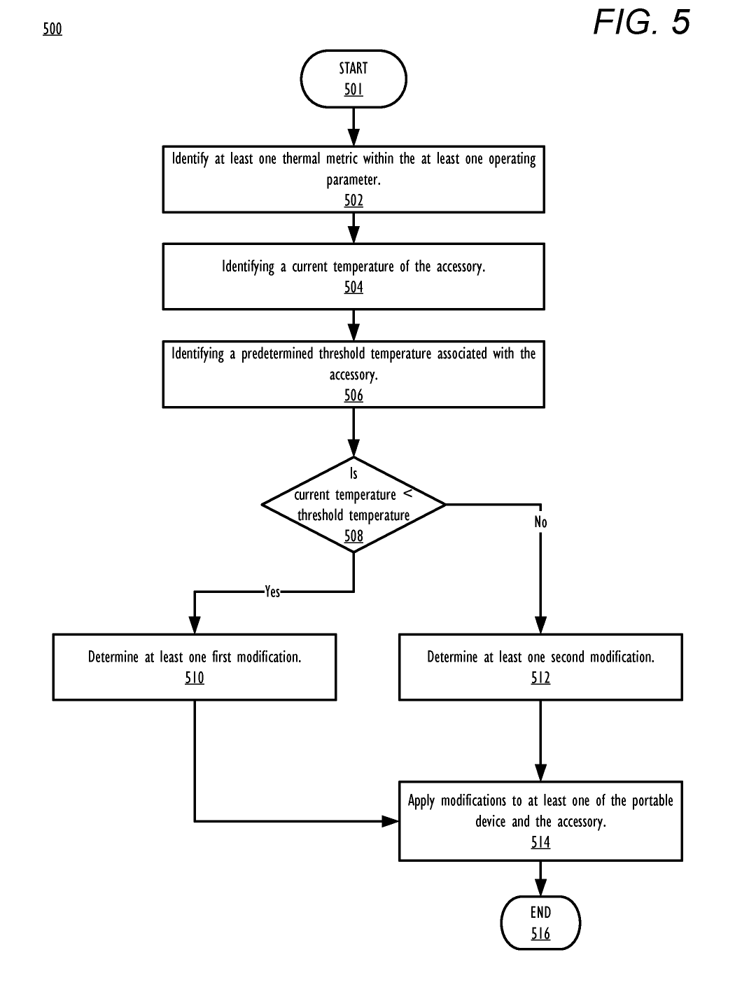

Referring now to FIG. 5, there is depicted a high-level flow-chart illustrating a method for determining a modification to apply to a portable device and/or accessory connected to the portable device based on a current temperature of the accessory, in accordance with one or more embodiments of the present disclosure. Aspects of the method are described with reference to the components of FIGS. 1-3C. Several of the processes of method 500 provided in FIG. 5 can be implemented by a processor (e.g., CPU 104) executing software code of respective AMU 117 within a portable device (e.g., portable device 200 of FIG. 2). The method processes described in FIG. 5 are generally described as being performed by portable device 200.

Method 500 commences at initiator block 501, then proceeds to block 502. At block 502, processor 104 identifies at least one thermal metric within operating parameters 214a-n. At block 504, processor 104 identifies a current temperature of accessory 220a. At block 506 processor 104 identifies a predetermined threshold temperature (e.g., threshold 244a) that is associated with a current operation and/or mode of accessory 220a. At decision block 508, processor 104 determines whether the current temperature of accessory 220a is higher than the predetermined threshold temperature. In response to determining the current temperature of accessory 220a is less than the predetermined threshold temperature, processor 104 determines at least one first modification that should be applied to at least one of portable device 200 and/or accessory 220a for the duration of communication 206 (block 510) to maintain the current temperature of accessory 220a below the predetermined threshold temperature. At block 514 processor 104 applies the determined modification(s) to at least one of portable device 200 and accessory 220a.

In response to determining the current temperature of accessory 220a is not lower than the predetermined threshold temperature, portable device 200 determines at least one second modification that should be applied to at least one of portable device 200 and/or accessory 220a for the duration of communication 206 (block 512) to lower the current temperature of accessory 220a below the predetermined threshold temperature. At block 514 the determined modification(s) is applied to at least one of portable device 200 and accessory 220a. Method 500 then terminates at end block 516.

In the above-described flow charts, one or more of the method processes may be embodied in a computer readable device containing computer readable code such that a series of steps are performed when the computer readable code is executed on a computing device. In some implementations, certain steps of the methods are combined, performed simultaneously or in a different order, or perhaps omitted, without deviating from the scope of the disclosure. Thus, while the method steps are described and illustrated in a particular sequence, use of a specific sequence of steps is not meant to imply any limitations on the disclosure. Changes may be made with regards to the sequence of steps without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object oriented programming language, without limitation. These computer program instructions may be provided to a processor of a general purpose computer, special purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain, or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals; but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A method comprising:
monitoring a portable device for a communication;
in response to detecting the communication, determining whether at least one accessory is coupled to the portable device; and
in response to determining at least one accessory is coupled to the portable device:
identifying at least one operating parameter associated with an operation of the at least one accessory;
determining, based on the at least one operating parameter, at least one modification to be applied to at least one of the portable device and the at least one accessory to restrict an operation of the at least one accessory for the duration of the communication; and
applying each of the at least one modification to a corresponding one of the portable device and the at least one accessory.

2. The method of claim 1, further comprising:
in response to detecting termination of the communication, reverting the at least one modification.

3. The method of claim 1, wherein applying the at least one modification further comprises at least one of:
issuing, to at least one output component of the portable device, a first notification that indicates the at least one accessory may be disconnected;
issuing, to at least one output component of the at least one accessory, a second notification that indicates the at least one accessory may be disconnected;
routing the communication to a particular output component of the portable device;
disabling at least one portion of the at least one accessory;
disabling at least one communications interface that interconnects the portable device and the at least one accessory; and
issuing, to the at least one accessory, a command that alters an operation of the at least one accessory.

4. The method of claim 1, wherein determining the at least one modification further comprises:
identifies a current output mode the portable device is configured to use to present the communication; and
determining, based on the at least one accessory and the current output mode, an alternate output mode for presenting the communication at the portable device, wherein the at least one modification includes the alternate operating mode.

5. The method of claim 1, wherein:
the at least one operating parameter includes at least one thermal metric; and
determining the at least one modification further comprises:
identifying, from the at least one thermal metric, a current temperature of the at least one accessory;
identifying a predetermined threshold temperature associated with the at least one accessory; and
determining the at least one modification based on the current temperature and the predetermined threshold temperature.

6. The method of claim 1, further comprising:
in response to coupling the at least one accessory to the portable device, collecting, via at least one sensor, operational data associated with the at least one accessory; and
generating, based on the operational data, at least one profile for the at least one accessory that categorizes an operation of the at least one accessory, wherein the at least one profile includes the at least one operating parameter, and wherein the at least one modification is determined based on the profile;
wherein the at least one profile identifies at least one of:
battery metrics associated with at least one battery;
thermal metrics associated with at least one of the portable device and the at least one accessory;
a tracked usage time associated with the at least one accessory;
an amount of heat output by the at least one accessory;
a power drawn from the portable device by the at least one accessory; and
a level of noise emitted by the at least one accessory.

7. The method of claim 1, further comprising:
determining an identifier associated with the at least one accessory; and
determining the at least one modification based on the identifier.

8. A portable device comprising:
a memory;
at least one communications interface that interconnects the portable device with at least one accessory;
at least one transceiver communicatively coupled to the processor and which detects a communication at the portable device; and
a processor that is coupled to the memory and which:
scans the at least one communications interface to identify at least one accessory that is coupled to the at least one communications interface;
in response to identifying the at least one accessory:
identifies at least one operating parameter in the memory that is associated with an operation of the at least one accessory;
determines, based on the at least one operating parameter, at least one modification to be applied to at least one of the portable device and the at least one accessory to restrict an operation of the at least one accessory for the duration of the communication;
applies each of the at least one modification to a corresponding one of the portable device and the at least one accessory; and
presents, based on the at least one modification. the communication on at least one output device from among at least one output device of the portable device and at least one output device of the at least one accessory.

9. The portable device of claim 8, wherein:
the at least one transceiver detects a termination of the communication; and
in response to detecting termination of the incoming communication, the processor reverts the at least one modification.

10. The portable device of claim 8, wherein in applying the at least one modification, the processor:
issues, to at least one output component of the portable device, a first notification that indicates the at least one accessory may be disconnected;
issues, to at least one output component of the at least one accessory via the at least one communications interface, a second notification that indicates the at least one accessory may be disconnected;
routes the communication to a particular output component of the portable device via the at least one communications interface;
issues, to the at least one accessory via the at least one communications interface, a first command that disables at least one portion of the at least one accessory;
disables the at least one communications interface; and
issues, to the at least one accessory via the at least one communications interface, a second command that reconfigures an operation of the at least one accessory.

11. The portable device of claim 8, wherein the processor:
identifies, from a configuration stored in the memory, a current output mode the portable device is configured to use to present the communication; and
determines, based on the at least one accessory and the current output mode, an alternate output mode for presenting the communication at the portable device, wherein the at least one modification includes the alternate operating mode.

12. The portable device of claim 8, wherein the at least one operating parameter includes at least one thermal metric, and wherein in determining the at least one modification, the processor:
identifies, from the at least one thermal metric:
a current temperature of the at least one accessory; and
a predetermined threshold temperature associated with the at least one accessory; and
determines the at least one modification based on the current temperature and the predetermined threshold temperature.

13. The portable device of claim 8, wherein:
the portable device includes at least one sensor that in response to coupling the at least one accessory to the portable device, collects operational data associated with the at least one accessory; and
the processor generates, based on the operational data, at least one profile for the at least one accessory, wherein the at least one profile categorizes an operation of the at least one accessory, wherein the at least one profile includes the at least one operating parameter, and wherein the at least one modification is determined based on the profile;
wherein the at least one profile identifies at least one of:
battery metrics associated with at least one battery;
thermal metrics associated with at least one of the portable device and the at least one accessory;
a tracked usage time associated with the at least one accessory;
an amount of heat output by the at least one accessory;
a power drawn from the portable device by the at least one accessory; and
a level of noise emitted by the at least one accessory.

14. The portable device of claim 8, wherein the processor:
identifies, from data stored in the memory, an identifier associated with the at least one accessory; and
determines the at least one modification based on the identifier.

15. A computer program product comprising:
a computer readable storage device; and
program code on the computer readable storage device that when executed by a processor associated with a portable device, the program code enables the portable device to provide the functionality of:
monitoring a portable device for a communication;
in response to detecting the communication, determining whether at least one accessory is coupled to the portable device; and
in response to determining at least one accessory is coupled to the portable device:
identifying at least one operating parameter associated with an operation of the at least one accessory;
determining, based on the at least one operating parameter, at least one modification to be applied to at least one of the portable device and the at least one accessory to restrict an operation of the at least one accessory for the duration of the communication; and
applying each of the at least one modification to a corresponding one of the portable device and the at least one accessory.

16. The computer program product of claim 15, wherein the program code for applying the at least one modification further comprises program code that enables the portable device to provide the functionality of at least one of:
issuing, to at least one output component of the portable device, a first notification that indicates the at least one accessory may be disconnected;
issuing, to at least one output component of the at least one accessory, a second notification that indicates the at least one accessory may be disconnected;
routing the communication to a particular output component of the portable device;
disabling at least one portion of the at least one accessory;
disabling at least one communications interface that interconnects the portable device and the at least one accessory; and
issuing, to the at least one accessory, a command that alters an operation of the at least one accessory.

17. The computer program product of claim 15, wherein
the at least one operating parameter includes at least one thermal metric; and
the program code for determining the at least one modification further comprises program code that enables the portable device to provide the functionality of:
identifying, from the at least one thermal metric, a current temperature of the at least one accessory;
identifying a predetermined threshold temperature associated with the at least one accessory; and
determining the at least one modification based on the current temperature and the predetermined threshold temperature.
